(19) United States
(12) Patent Application Publication
(10) Pub. No.: US 2006/0106924 A1
(43) Pub. Date: May 18, 2006

(54) Data-processing device, communication method, and computer program

(75) Inventor: Nobuaki Fukasawa, Nakano-ku (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/268,438

(22) Filed: Nov. 7, 2005

(30) Foreign Application Priority Data
Nov. 12, 2004 (JP) 2004-329561

(51) Int. Cl. G06F 15/173

(52) U.S. Cl. 709/223; 709/224

(57) ABSTRACT

A data-processing device is provided which communicates with an external device through a proxy server. The device includes an acquiring unit that acquires sizes of data that can be transmitted through each of a plurality of transmission modes of the proxy server, a determining unit that compares the sizes corresponding to each transmission mode with a size of data to be transmitted and determines a transmission mode to be used on the basis of the result of the comparison, and a transmitting unit that transmits data to the external device in the determined transmission mode.

### BACKGROUND OF THE INVENTION

1. Field of the Invention

The present invention relates to data-processing devices, communication methods, and computer programs. In particular, the present invention relates to a data-processing device, a communication method, and a computer program that are suitably used so that the data-processing device can communicate with an external device through another data-processing device, for example, a proxy server.

2. Description of the Related Art

In some cases, a data-processing device, for example, a proxy server, has been provided between a local area network (LAN) that constitutes an intra-company system and the Internet outside the intra-company system to improve security of the intra-company system. Moreover, in some circumstances, data in a WWW server connected to the Internet has been temporarily stored (cached) in a proxy server to reduce network traffic.

In such a network system in which a proxy server is provided, the proxy server receives a command from a data-processing device and sends an instruction specified by the received command to a server (see Japanese Patent Laid-Open No. 2002-189626).

As described above, when a data-processing device transmits data to an external device connected to the Internet, the data may be transmitted to the external device through a proxy server. Thus, when the data-processing device transmits a large amount of data to an external device, data transmission may be restricted by the proxy server.

Accordingly, when a data-processing device transmits data to an external device through another data-processing device, for example, a proxy server, data should be transmitted so as to fit to sizes of data that can pass through the other data-processing device.

### SUMMARY OF THE INVENTION

A data-processing device according to a first aspect of the present invention is provided which communicates with an external device through a proxy server. The data-processing device includes an acquiring unit that acquires sizes of data that can be transmitted through each of a plurality of transmission modes of which the proxy server may utilize. A determining unit compares the sizes corresponding to each transmission mode with a size of data to be transmitted and determines a transmission mode to be used on the basis of the result of the comparison. A transmitting unit then transmits data to the external device in the transmission mode determined by the determining unit.

In another aspect of the present invention, a device communicates with a data-processing device through a proxy server. The device includes a receiving unit that receives information that indicates a data transmission mode from the data-processing device through the proxy server, a notifying unit that notifies the data-processing device through the proxy server of information that indicates a data transmission destination in a case where the transmission mode indicated by the information received by the receiving unit is used, and a data-receiving unit that receives data that is transmitted to the data transmission destination indicated by the information sent by the notifying unit.

According to a second embodiment of the present invention, a data-processing device communicates with an external device through another data-processing device. The data-processing device includes an acquiring unit that acquires sizes of data that can be transmitted through each of a plurality of transmission modes that the other data-processing device may utilize. A determining unit compares the sizes corresponding to each transmission mode, which are acquired by the acquiring unit, with a size of data to be transmitted and determines a transmission mode to be used on the basis of the result of the comparison. A transmitting unit transmits data to the external device in the transmission mode determined by the determining unit.

Still further, according to another embodiment of the present invention, a communication method is provided in which a plurality of devices communicate with each other through a proxy server. The method includes acquiring sizes of data that can be transmitted through each of a plurality of transmission modes that the proxy server may utilize. Next, the sizes corresponding to each transmission mode are compared with a size of data to be transmitted and a transmission mode is determined on the basis of the result of the comparison. And finally, the plurality of devices communicate with each other in the determined transmission mode through the proxy server.

And, according to still yet another embodiment of the present invention, a computer program is provided containing computer-executable instructions stored in a computer readable medium that causes a computer to perform communication with an external device through a proxy server having a plurality of transmission modes. The computer program includes computer-executable instructions for acquiring sizes of data that can be transmitted in each of the plurality of transmission modes through the proxy server, computer-executable instructions for comparing the sizes corresponding to each transmission mode with a size of data to be transmitted, computer-executable instructions for determining a transmission mode of the data to be transmitted on the basis of the result of the comparison, and computer-executable instructions for transmitting data to the external device in the determined transmission mode.

Further features and aspects of the present invention will become apparent from the following description of exemplary embodiments with reference to the attached drawings.

### BRIEF DESCRIPTION OF THE DRAWINGS

FIG. 1 shows the architecture of an exemplary network system according to an embodiment of the present invention.

FIG. 2 shows the internal architecture of an exemplary personal computer (PC) according to the embodiment of the present invention.

FIG. 3 shows the internal architecture of an exemplary printer device according to the embodiment of the present invention.

FIG. 4 is a sequence diagram showing an exemplary operation between a client and a server according to the embodiment of the present invention.

FIG. 5 is a flowchart showing an exemplary operation of the client according to the embodiment of the present invention.

FIG. 6 is a flowchart showing exemplary details of data transmission request processing according to the embodiment of the present invention.

FIG. 7 is a flowchart showing exemplary details of data transmission processing according to the embodiment of the present invention.

FIG. 8 is a flowchart showing an exemplary operation of the server according to the embodiment of the present invention.

FIG. 9 shows an example of “create_job” procedure according to the embodiment of the present invention.

FIG. 10 shows an example of “create_jobResponse” according to the embodiment of the present invention.

FIG. 11 shows an example of a memory map of a CD-ROM that is an exemplary storage medium according to the embodiment of the present invention.

### DESCRIPTION OF THE EMBODIMENTS

An exemplary embodiment according to the present invention will now be described with reference to the drawings. In this embodiment, an exemplary network system will be described in detail, in which software on a server and software on a client provide users with service without the necessity of a person making a decision or confirmation, using Web service techniques.

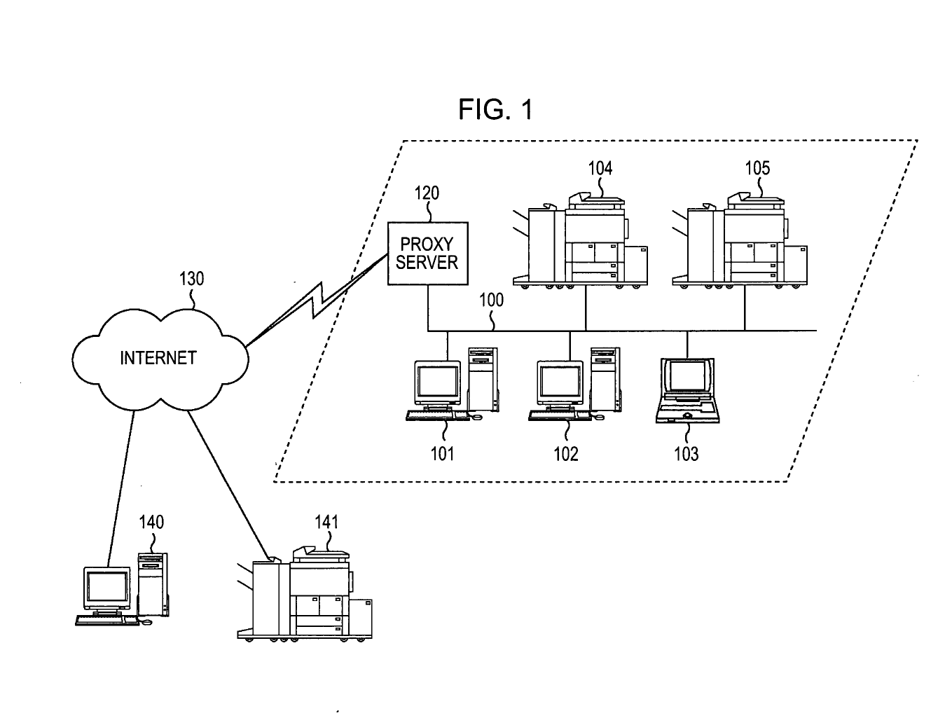

FIG. 1 shows the architecture of an exemplary network system according to this embodiment. The network system includes server personal computers (PCs) 101 and 102, a client PC 103, and multi-function printers (MFPs) 104 and 105. The server PCs 101 and 102, the client PC 103, and the MFPs 104 and 105 are connected to a LAN 100.

The server PCs 101 and 102 provide the client PC 103 with various types of Web services. The MFPs 104 and 105 serve as servers that provide various types of Web service and also serve as clients that receive various types of Web service in some cases. The server PCs 101 and 102 and the MFPs 104 and 105 respond to a query about service from the client PC 103 and provide service in response to a service request from the client PC 103.

The client PC 103 is configured to submit a query about service to the server PCs 101 and 102 and the MFPs 104 and 105. The client PC 103 also is configured to submit a service request to the server PCs 101 and 102 and the MFPs 104 and 105 and further receives service. The network further includes a proxy server 120 connected to the LAN 100. All terminals connected to the LAN 100 access the Internet 130, which is an external network, through the proxy server 120.

Reference numeral 140 denotes a server PC. The server PC 140 can provide Web service and is connected to the Internet 130. The client PC 103 and the MFPs 104 and 105 in the LAN 100, which receive Web service, can access the server PC 140 through the proxy server 120 and the Internet 130.

Reference numeral 141 denotes an MFP. The MFP 141 can be a server that provides Web service and is connected to the Internet 130. The client PC 103 and the MFPs 104 and 105 connected to the LAN 100, which receive Web service, can access the MFP 141 through the proxy server 120 and the Internet 130.

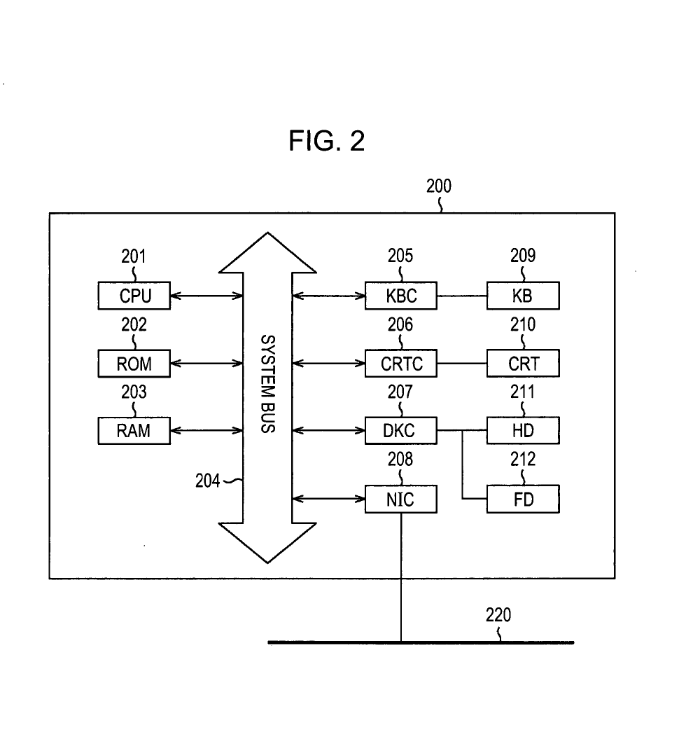

FIG. 2 shows the internal architecture of an exemplary PC. Internal structures of the server PCs 101 and 102, the client PC 103, and the server PC 140 in FIG. 1 are similar to that shown in FIG. 2.

In FIG. 2, a PC 200 includes a CPU 201, a ROM 202, a RAM 203, a system bus 204, a keyboard controller (KBC) 205, a cathode-ray tube controller (CRTC) 206, a disk controller (DKC) 207, a network interface card (NIC) 208, a keyboard (KB) 209, a cathode-ray tube (CRT) display 210, a hard disk (HD) 211, and a flexible disk (FD) drive 212. The CPU 201 executes various types of software stored in the ROM 202 or the HD 211 or various types of software supplied from the FD drive 212. The CPU 201 also performs overall control of components connected to the system bus 204. The RAM 203 serves as a main memory, a work area, and the like of the CPU 201. The KBC 205 controls command input from the KB 209, a pointing device (not shown), or the like. The CRTC 206 controls display of the CRT display 210. The DKC 207 controls access to the HD 211 and the FD drive 212. The HD 211 and/or the FD drive 212 store a boot program, a program that performs an operation according to this embodiment, various types of applications, edit files, user files, and the like. The NIC 208 bi-directionally exchanges data with a network printer, other network devices, or other PCs through a LAN 220. In this embodiment, the LAN 220 is the same as the LAN 100 in FIG. 1.

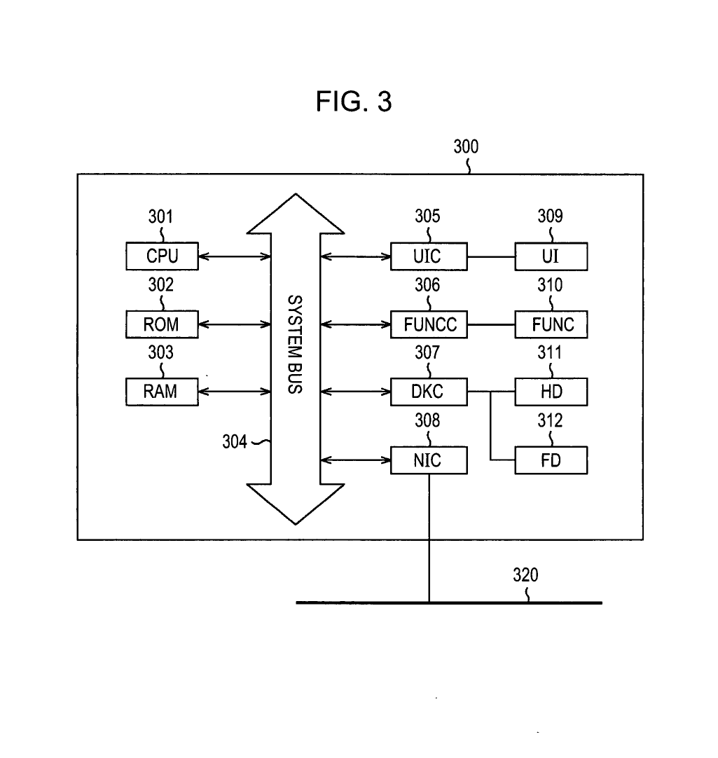

FIG. 3 shows the internal structure of a typical printer device. Exemplary internal structures of the MFPs 104, 105, and 141 in FIG. 1 are similar to that as shown in FIG. 3.

In FIG. 3, a printer device 300 includes a CPU 301, a ROM 302, a RAM 303, a system bus 304, a user interface controller (UIC) 305, a function controller (FUNCC) 306, a DKC 307, an NIC 308, a user interface (UI) 309, a function (FUNC) 310, an HD 311, and an FD drive 312. The CPU 301 executes various types of programs stored in the ROM 302 or the HD 311 or various types of programs supplied from the FD drive 312. The CPU 301 also performs overall control of components connected to the system bus 304. The RAM 303 serves as a main memory, a work area, and the like of the CPU 301. The UIC 305 controls, for example, the display on the UI 309 and command input from the UI 309.

The FUNCC 306 runs or controls the FUNC 310, which is a function unique to each device. For example, when the printer device 300 is a monochrome printer, a monochrome print engine controller and a monochrome print engine are provided. When the printer device 300 is a color printer, a color print engine controller and a color print engine are provided. Moreover, when the printer device 300 is an MFP, the FUNCC 306 and the FUNC 310 of each function are provided.

The DKC 307 controls access to the HD 311 and the FD drive 312. The HD 311 and the FD drive 312 store a boot program, a program that performs operations according to this embodiment, various types of applications, and data files. The NIC 308 bi-directionally exchanges data with a network printer, other network devices, or other PCs through a LAN 320. In this embodiment, the LAN 320 is similar to the LAN 100 in FIG. 1.

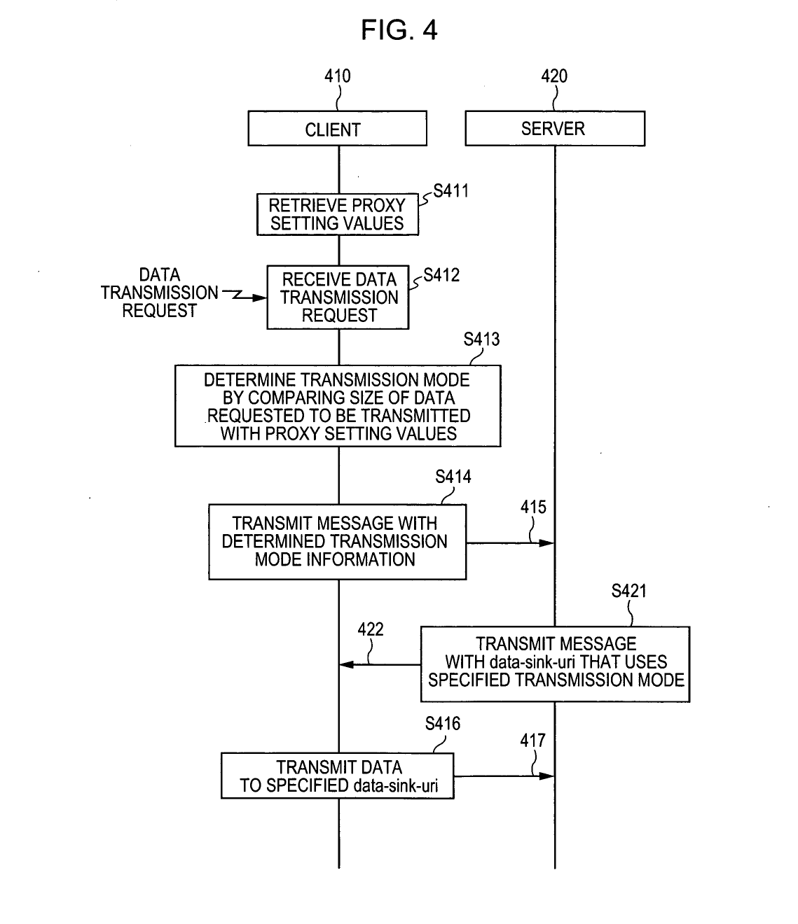

FIG. 4 is a sequence diagram showing an exemplary operation between a client and a server when Web service is applied to the network system according to this embodiment. Reference numerals 410 and 420 denote a client and a server, respectively. The client 410 corresponds to, for example, the MFP 104 in FIG. 1. The server 420 corresponds to, for example, the server PC 140 in FIG. 1. The client 410 and the server 420 are adapted to communicate with each other through the proxy server 120.

In step S411, the client 410 acquires the maximum transmission data sizes that are set as setting values for each of the plurality of transmission modes in the proxy server 120 by a user or during power-up. Subsequently, in step S412, the client 410 receives a data transmission request from a user, another PC, or the like. Then, in step S413, the client 410 compares the size of data requested to be transmitted with the maximum transmission data sizes for each of the respective transmission modes in the proxy server 120, which are acquired in step S411, and determines a transmission mode to be used, wherein the maximum transmission data size of the transmission mode is equal to or more than the size of the data requested to be transmitted.

Then, in step S414, the client 410 generates a “create_job” procedure, adds the transmission mode information determined in step S413 to the create_job, and transmits the create_job with the transmission mode information to the server 420 as a message 415. In step S421, the server 420, which receives the message 415, transmits a “create_jobResponse” with a “data-sink-uri” tag that uses the specified transmission mode to the client 410 as a message 422. In step S416, the client 410, which receives the message 422, transmits data to the specified data-sink-uri. In the way described above, the transmission mode corresponding to the size of the data requested to be transmitted is determined, and transmission of data 417 in the determined transmission mode is started.

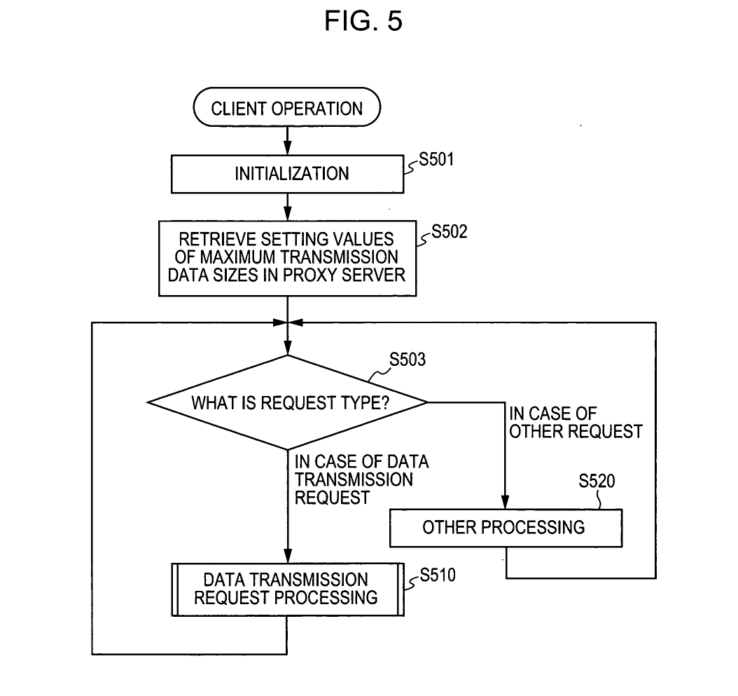

FIG. 5 is a flowchart showing an exemplary operation of the client 410 shown in FIG. 4. In step S501, the client 410 performs initialization during power-up. Then, in step S502, the client 410 retrieves at least one set of information of a transmission mode that can be used in the proxy server 120 and the setting value of the maximum transmission data size of the transmission mode. The client 410 may obtain a setting value that is set as the maximum transmission data size by a user or obtain a setting value on the basis of a response to a query about the setting value from the proxy server 120.

Subsequently, in step S503, the client 410 waits for various types of requests, and determines a type of a request when the request is submitted. When it is determined that the request is a data transmission request, the data transmission request is processed in step S510. Then, the client 410 goes back to step S503 and waits for various types of requests. On the other hand, when the request is a request other than a data transmission request, the client 410 performs processing other than the data transmission request processing in step S520. Then, the client 410 goes back to step S503 and waits for various types of requests.

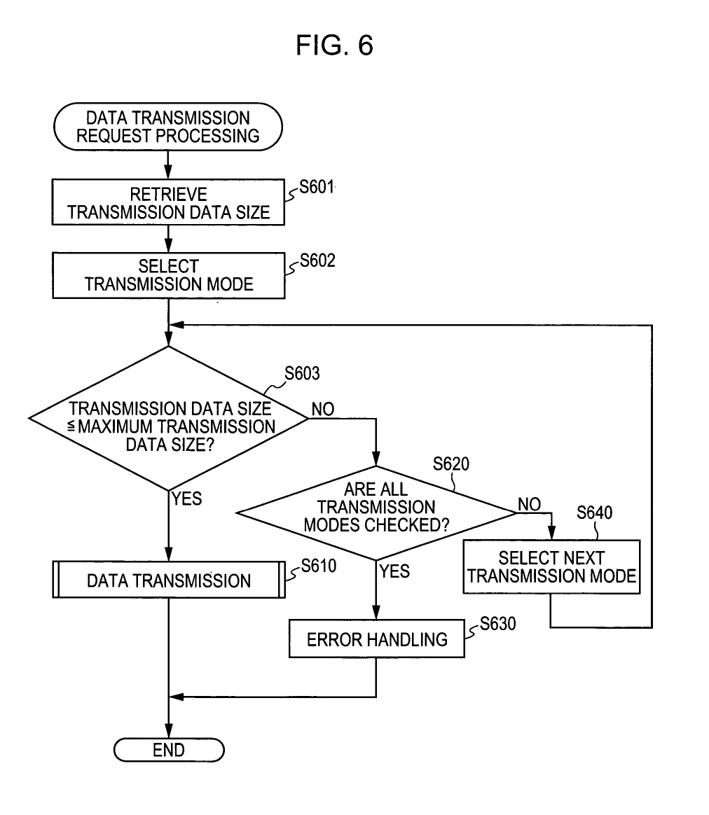

FIG. 6 is a flowchart showing exemplary details of data transmission request processing (step S510) shown in FIG. 5. In step S601, the client 410 retrieves the size of data requested to be transmitted. Then, in step S602, the client 410 selects one from a plurality of available transmission modes, the information of which is retrieved in step S502 in FIG. 5 (i.e., the transmission mode that can be used in the proxy server 120).

Then, in step S603, the client 410 compares the maximum transmission data size of the selected transmission mode with the size of the data requested to be transmitted. When it is determined that the transmission data size is equal to or less than the maximum transmission data size as a result of this comparison, the client 410 determines the transmission mode selected in step S602 as a transmission mode to be used and transmits the data in the determined transmission mode in step S610.

On the other hand, when the transmission data size is more than the maximum transmission data size, the client 410 determines whether all of the possible plurality of transmission modes (the information of which is retrieved in step S502 in FIG. 5) have been entirely checked in step S620. When all of the possible plurality of transmission modes have been entirely checked, it is determined that the data cannot be transmitted in any transmission mode. Thus, the client 410 performs error handling in step S630. On the other hand, if the all of the possible plurality of transmission modes have not been entirely checked yet, the client 410 selects another one (the next transmission mode) from the plurality of transmission modes, which have not been checked yet, in step S640. Then, the client 410 goes back to step S603.

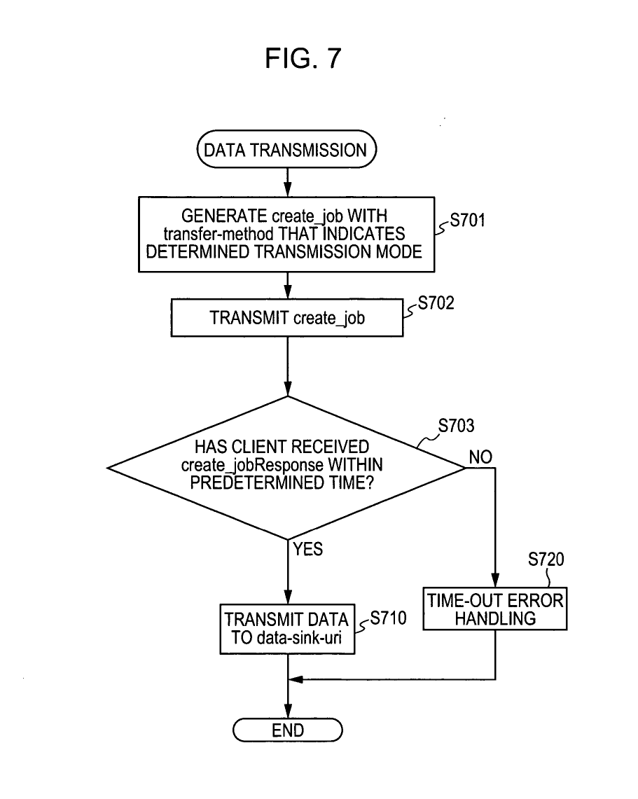

FIG. 7 is a flowchart showing exemplary details of data transmission processing (step S610) shown in FIG. 6. In step S701, the client 410 generates a create_job procedure that includes a transfer-method tag that indicates the transmission mode determined on the basis of the result of the determination in step S603 in FIG. 6. Then, in step 702, the client 410 transmits the generated create_job to the server 420 shown in FIG. 4. The aforementioned create_job is the message 415 shown in FIG. 4.

Subsequently, in step S703, the client 410 waits for a predetermined time to receive a create_jobResponse (the response sent in the message 422 shown in FIG. 4) and determines whether the client 410 receives the create_jobResponse in the predetermined time. When the client 410 receives create_jobResponse in the predetermined time, the client 410 recognizes the data-sink-uri tag included in the received create_jobResponse and transmits the data 417 (shown in FIG. 4) to the data-sink-uri in step S710. When the client 410 has completed transmission of all data, the client 410 completes data transmission processing. On the other hand, when the client 410 does not receive create_jobResponse in the predetermined time and time-out (TimeOut) occurs, the client 410 performs time-out error handling in step S720.

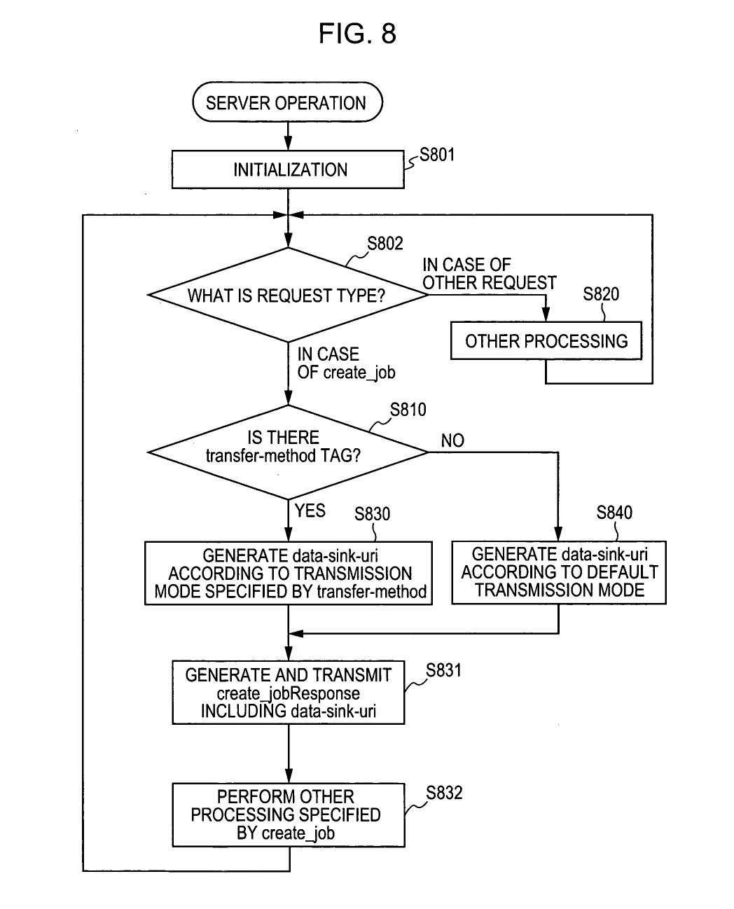

FIG. 8 is a flowchart showing an exemplary operation of the server 420 shown in FIG. 4. In step S801, the server 420 performs initialization during power-up. Subsequently, in step S802, the server 420 waits for various types of requests and determines the type of a request upon receiving the request. When it is determined that the server 420 has received the create_job procedure (the message 415) from the client 410 shown in FIG. 4 as a result of this determination, the server 420 determines whether a transfer-method tag exists in the received create_job from step S810.

When it is determined that a transfer-method tag exists in the received create_job as a result of this determination, the server 420 generates a data-sink-uri tag according to the transmission mode specified by transfer-method in step S830. Then, in step S831, the server 420 generates a create_jobResponse (the response in message 422) that includes the generated data-sink-uri and transmits this create_jobResponse to the client 410. Subsequently, in step S832, the server 420 performs other processing that is required for the create_job procedure. Then, the server 420 goes back to step S802.

In step S802, if other requests besides a create_job are received, such other processing is performed in step S820. Subsequently, after the server 420 performs the other processing in step S820, it goes back to step S802.

On the other hand, when no transfer-method tag exists in the received create_job, the server 420 generates a data-sink-uri according to a default transmission mode specified in the server 420 in step S840. Then, as described above, the server 420 generates the create_jobResponse (the response in message 422) that includes the generated data-sink-uri and transmits this create_jobResponse to the client 410. Subsequently, the server 420 performs other processing in step S832 and goes back to step S802.

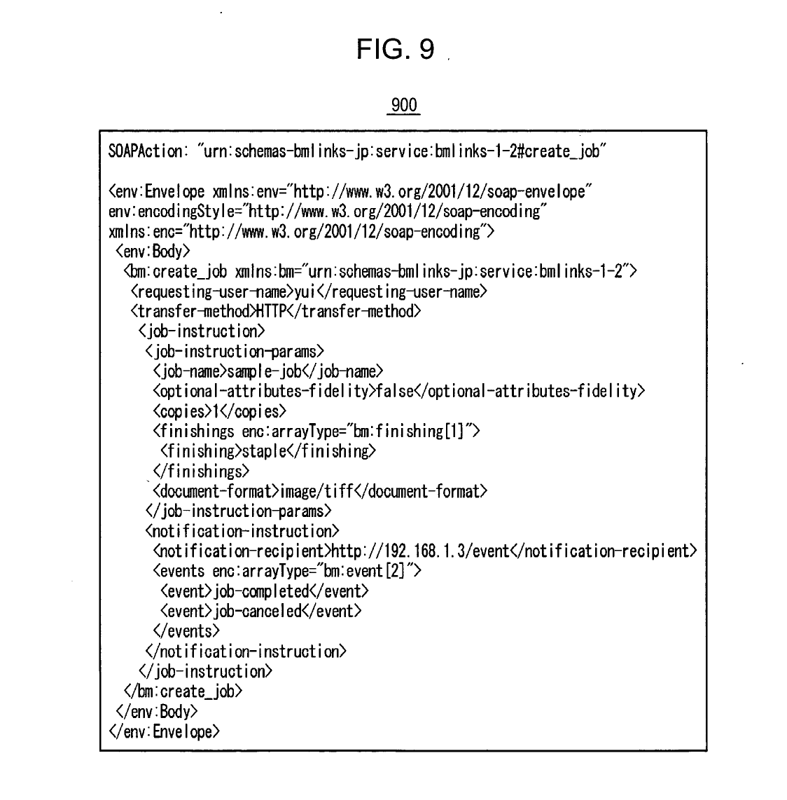

FIG. 9 shows an example of a create_job procedure that is included the message 415 shown in FIG. 4. In the create_job 900 shown in FIG. 9, the transmission mode determined in step S603 in FIG. 6 is represented by “<transfer-method>HTTP</transfer-method>”. In the example shown in FIG. 9, the determined transmission mode is HTTP.

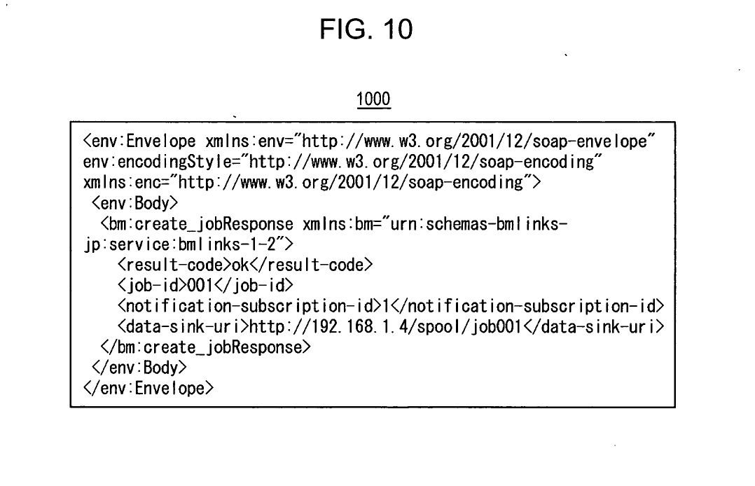

FIG. 10 shows an example of the create_jobResponse that is the message 422 shown in FIG. 4. The data-sink-uri tag generated in step S830 in FIG. 8 is represented by “<data-sink-uri>http://192.168.1.4/spool/job001</data-sink-uri>”. The data-sink-uri tag instructs the client 410 to transmit data to this URI.

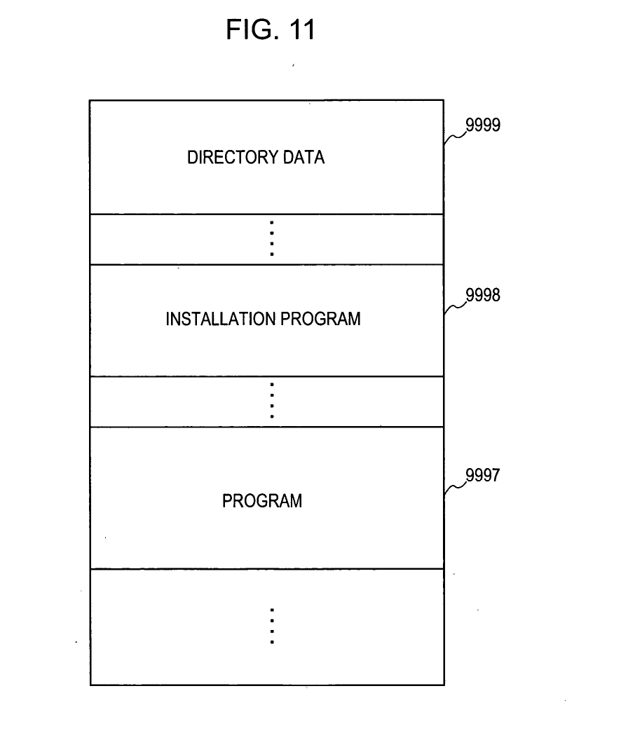

FIG. 11 shows an example of a memory map of a CD-ROM that is a typical storage medium. In FIG. 11, the CD-ROM includes a region 9999 that stores directory data, a region 9997 that stores a program that performs functions of the network system according to this embodiment, and a region 9998 that stores an installer program for installing the program, which performs the functions of the network system according to this embodiment. When the program according to this embodiment is installed in the printer device 300, the installer program stored in the region 9998 is loaded into the system and executed by the CPU 301. Then, the installer program executed by the CPU 301 reads the program according to this embodiment from the region 9997 and stores the program in the HD 311.

As described above, in this embodiment, the client 410 retrieves setting values of the maximum transmission data sizes of respective transmission modes, for example, HTTP and FTP, in the proxy server 120 and selects a transmission mode, the maximum transmission data size of which is larger than the size of transmission data. Then, the client 410 transmits the data 417 to the server 420 in the selected transmission mode. Thus, a transmission mode for transmitting as a large amount of data as possible can be automatically determined within limits set in the proxy server 120.

The functions according to this embodiment may be applied to a system or an integrated apparatus that includes a plurality of devices, for example, a host computer, an interface device, and a reader, or an apparatus including a single device.

### Other Embodiments

It is apparent that the present invention is also implemented by providing to a system or an apparatus a storage medium that stores program codes of software that perform the functions according to the embodiment described above and by causing a computer (a CPU or an MPU) included in the system or in the apparatus to read and execute the program codes stored in the storage medium.

In this case, the program codes read from the storage medium perform the novel functions according to the present invention, and thus the present invention includes the storage medium that stores the program codes.

Typical storage media for providing the program codes are floppy (trademark) disks, hard disks, optical disks, magneto-optical disks, CD-ROMs, CD-Rs, magnetic tapes, nonvolatile memory cards, flash memory, ROMs or the like.

An OS operating on a computer may execute some or all of the actual processing to perform the functions of the embodiment described above according to instructions from the program codes according to the present invention.

Moreover, the program codes read from the storage medium may be written to a memory included in, for example, a function expansion board inserted in a computer or a function expansion unit connected to a computer. Then, for example, a CPU included in the function expansion board, the function expansion unit, or the like may execute some or all of the actual processing to perform the functions of the embodiment described above according to instructions from the program codes.

Accordingly, the present invention can be applied to a case where the program codes of the software that perform the functions according to the embodiment described above are distributed to a requester from the storage medium, which stores the program codes, through a network, for example, a personal computer network.

According to the present invention, a data-processing device retrieves the maximum sizes of data that can be transmitted through a proxy server for respective transmission modes upon transmitting data to a server unit through the proxy server. Then, the data-processing device determines a data transmission mode on the basis of the result of comparing the retrieved maximum sizes with the size of data to be transmitted and communicates with the server unit in the determined transmission mode through the proxy server. In this way, a transmission mode can be determined so that data is transmitted to the server unit within limits set in the proxy server.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-329561 filed Nov. 12, 2004, which is hereby incorporated by reference herein in its entirety.

1. A data-processing device adapted to communicate with an external device through a proxy server having a plurality of transmission modes, the data-processing device comprising:
an acquiring unit configured to acquire sizes of data that can be transmitted through each of the plurality of transmission modes of the proxy server;
a determining unit configured to compare the sizes corresponding to each transmission mode with a size of data to be transmitted, and to determine a transmission mode to be used on the basis of the result of the comparison; and
a transmitting unit configured to transmit data to the external device in the determined transmission mode.

2. The data-processing device according to claim 1, further comprising:
a notifying unit configured to notify the external device of the determined transmission mode through the proxy server; and
a receiving unit configured to receive information that indicates a data transmission destination in a case where the determined transmission mode is used from the external device through the proxy server after the notifying unit notifies the external device of the determined transmission mode,
the transmitting unit transmitting data to the data transmission destination indicated by the information received by the receiving unit in the determined transmission mode.

3. A device that communicates with a data-processing device through a proxy server, the device comprising:
a mode receiver configured to receive information that indicates a data transmission mode from the data-processing device through the proxy server;
a mode notifier configured to notify the data-processing device through the proxy server of information that indicates a data transmission destination in a case where the transmission mode indicated by the information received by the mode receiver is used; and
a data-receiver configured to receive data that is transmitted to the data transmission destination indicated by the information sent by the mode notifier.

4. A first data-processing device that communicates with an external device through a second data-processing device which has a plurality of transmission modes, the first data-processing device comprising:
an acquiring unit adapted to acquire sizes of data that can be transmitted through each of the plurality of transmission modes of the second data-processing device;
a determining unit adapted to compare the sizes corresponding to each transmission mode with a size of data to be transmitted, and to further determine a transmission mode to be used on the basis of the result of the comparison; and
a transmitting unit adapted to transmit data to the external device in the determined transmission mode.

5. A communication method in which a plurality of devices are adapted to communicate with each other through a proxy server which has a plurality of transmission modes, the method comprising:
acquiring sizes of data that can be transmitted with respect to each of the transmission modes of the proxy server;
comparing the sizes corresponding to each transmission mode with a size of data to be transmitted;
determining a transmission mode to be used on the basis of the result of the comparison; and
causing the plurality of devices to communicate with each other in the determined transmission mode through the proxy server.

6. The method according to claim 5, further comprising:
notifying one device of the plurality of devices through the proxy server of the determined transmission mode; and
notifying another device of the plurality of devices through the proxy server of a data transmission destination in a case where the determined transmission mode is used,
wherein data is transmitted to the data transmission destination in the determined transmission mode.

7. A computer program containing computer-executable instructions stored in a computer readable medium that causes a computer to perform communication with an external device through a proxy server having a plurality of transmission modes, the computer program comprising:
computer-executable instructions for acquiring sizes of data that can be transmitted in each of the plurality of transmission modes through the proxy server;
computer-executable instructions for comparing the sizes corresponding to each transmission mode with a size of data to be transmitted;
computer-executable instructions for determining a transmission mode of the data to be transmitted on the basis of the result of the comparison; and
computer-executable instructions for transmitting data to the external device in the determined transmission mode.
